(19) United States
(12) Patent Application Publication
(10) Pub. No.: US 2011/0261990 A1
(43) Pub. Date: Oct. 27, 2011

(54) SPEAKER UNIT, MANUFACTURING METHOD THEREOF, AND PORTABLE INFORMATION TERMINAL

(75) Inventors: Kazuyuki Kosuda, Osaka (JP); Yuki Hatanaka, Hyogo (JP)

(73) Assignee: SANYO ELECTRIC CO., LTD., Moriguchi-shi, Osaka (JP)

(21) Appl. No.: 13/141,548

(22) PCT Filed: Nov. 11, 2009
(86) PCT No.: PCT/JP2009/069158

§ 371 Date: Jun. 22, 2011

(30) Foreign Application Priority Data
Dec. 22, 2008 (JP) 2008-326180

(51) Int. Cl. H04R 1/00; H04R 31/00

(52) U.S. Cl. 381/398; 29/594

(57) ABSTRACT

A frame includes terminals. A diaphragm is supported by a frame so as to vibrate in one direction. A magnet is fixed to frame. A voice coil includes a winding portion and wire portions. Winding portion is fixed to diaphragm so as to receive a magnetic field from magnet. Wire portions and serve to electrically connect wiring portion and terminals, respectively. Wire portions have bending portions bent in one direction from winding portion towards terminals.

### TECHNICAL FIELD

The present invention relates to a speaker unit, a method of manufacturing a speaker unit, and a portable information terminal. Particularly, the present invention relates to a speaker unit including a voice coil, a method of manufacturing a speaker unit, and a portable information terminal.

### BACKGROUND ART

Some speaker units employ voice coils. According to Japanese Patent Laying-Open No. 2002-354583, for example, a speaker includes a frame, a diaphragm, a voice coil, and a pair of terminal members. The frame supports the peripheral rim region of the diaphragm from the bottom side. The voice coil is fixed to the bottom of the diaphragm. A pair of lead wires extending from the voice coil is conductively fixed to the pair of terminal members attached to the frame.
Patent Document 1: Japanese Patent Laying-Open No. 2002-354583

### DISCLOSURE OF THE INVENTION

### Problems to be Solved by the Invention

In recent years, the field of portable information terminals such as a DSC (Digital Still Camera), PDA (Personal Digital Assistants), and PC (Personal Computer) is moving towards reducing the size, thickness, and weight of the terminal. The space for mounting a speaker unit in a portable information terminal is further restricted. Particularly, the space between the frame and diaphragm has become smaller. The wire portion to connect the winding portion of the voice coil and the frame terminal must pass through this restricted space. Therefore, the wire portion connecting the winding portion and the terminal linearly, as in the approach of aforementioned publication, causes a problem in the displacement of the voice coil. Specifically, when the voice coil is displaced towards the diaphragm, the wire portion may be pulled excessively to be disconnected. When the voice coil is displaced in an opposite direction, there is a problem that the wire portion may collide against the frame or another member attached to the frame such as the yoke.

The present invention is directed to the problems set forth above. An object of the present invention is to provide a speaker unit that can prevent the wire portion from being disconnected or colliding against another member, a method of manufacturing a speaker unit, and a portable information terminal.

### Means for Solving the Problems

A speaker unit of the present invention includes a frame, a diaphragm, a magnet, and a voice coil. The frame includes a terminal. The diaphragm is supported by the frame so as to vibrate in one direction. The magnet is fixed to the frame. The voice coil includes a winding portion and a wire portion. The winding portion is fixed to the diaphragm so as to receive a magnetic field from the magnet. The wire portion serves to electrically connect the winding portion and the terminal. The wire portion has a bending portion bent in one direction from the winding portion towards the terminal.

According to the speaker unit of the present invention, the wire portion has a bending portion bent in one direction from the winding portion towards the terminal. Since the tension of the wire portion can be alleviated by the stretch of the bending portion, disconnection of the wire portion can be prevented. The wire portion allows the distance from the frame to be further ensured at the region from the winding portion to the bending portion, as compared to the case where the wire portion extends linearly. Therefore, the wire portion can be prevented from colliding against the frame or another member attached to the frame.

In the speaker unit of the present invention, the winding portion is preferably wound to take a polygonal shape in plan view. By immobilizing the corner of the winding portion, deviation in position caused by rotation of the winding portion can be prevented.

The portable information terminal of the present invention includes the speaker unit set forth above. Accordingly, the mounting space for the speaker unit can be reduced while preventing disconnection and/or collision of the wire portion. Thus, a portable information terminal can be further reduced in size, thickness, or weight.

A method of manufacturing a speaker unit of the present invention is directed to a speaker unit including a frame, a diaphragm, a magnet, and a voice coil. The frame includes a terminal. The diaphragm is supported by the frame so as to vibrate in one direction. The magnet is fixed to the frame. The voice coil includes a winding portion and a wire portion. The winding portion is fixed to the diaphragm so as to receive a magnetic field from the magnet. The wire portion serves to electrically connect the winding portion and the terminal. The wire portion has a bending portion bent in one direction from the winding portion towards the terminal. A method of manufacturing a speaker unit of the present invention includes the following steps.

The wire portion is arranged spaced apart from the terminal, and so as to traverse over the terminal in plan view. By pressing the wire portion against the terminal in a state where a shaping member is located between the frame and wire portion, the wire portion is bent at the region in contact with the shaping member and connected to the terminal.

By the wire portion being bent at the region in contact with the shaping member according to the method of manufacturing a speaker unit of the present invention, a bending portion can be formed at the wire portion. Formation of this bending portion can be carried out simultaneous to connecting the wire portion to the terminal.

In the method of manufacturing a speaker unit of the present invention, the winding portion is preferably wound to take a polygonal shape in plan view. Thus, by immobilizing the corner of the winding portion, deviation in position caused by rotation of the winding portion can be prevented.

### Effects of the Invention

According to the speaker unit, the manufacturing method thereof, and the portable information terminal of the present invention set forth above, disconnection and/or collision of the wire portion with another member can be prevented.

### BEST MODE FOR CARRYING OUT THE INVENTION

Embodiments of the present invention will be described hereinafter with reference to the drawings.

### First Embodiment

FIG. 1 is a schematic plan view of a configuration of a speaker unit according to a first embodiment of the present invention. FIG. 2 is a schematic sectional view taken along line II-II of FIG. 1. FIG. 3 is a schematic enlarged view in the vicinity of arrow III in FIG. 2.

Referring to FIGS. 1-3, a speaker unit 81 of the present embodiment includes a frame 31, a diaphragm 32, a magnet 33, a pole piece 41, a yoke 42, and a voice coil 50.

Frame 31 includes a pair of terminals 61 and 62. Diaphragm 32 is supported by frame 31 so as to vibrate in the vibrating direction DR (one direction). Each of terminals 61 and 62 has a surface for a wire portion to be connected. This surface is perpendicular to vibrating direction DR.

Magnet 33 is arranged on yoke 42. Yoke 42 is attached to frame 31. By this configuration, magnet 33 is fixed to frame 31 via yoke 42. Pole piece 41 is arranged above magnet 33, apart from yoke 42. By this configuration, the magnetic field from magnet 33 is guided to pass between pole piece 41 and yoke 42.

Voice coil 50 includes a winding portion 55, and a pair of wire portions 51 and 52.

Winding portion 55 is fixed to diaphragm 32 so as to receive the magnetic field from magnet 33 between pole piece 41 and yoke 42. The face of diaphragm 32 where winding portion 55 is attached is substantially perpendicular to the vibrating direction DR (FIG. 1). Winding portion 55 is formed of a wire wound around an axis in the vibrating direction DR, and can be driven in the vibrating direction DR (FIG. 1) by the Lorentz force. In plan view (FIG. 1), winding portion 55 is wound to take a polygonal shape such as a hexagon.

Wire portions 51 and 52 serve to electrically connect terminals 61 and 62, respectively, with winding portion 55. Wire portions 51 and 52 are attached to terminals 61 and 62, respectively, by compression at a compression portion CP. Each of wire portions 51 and 52 has a bending portion BD bent in the vibrating direction DR, from winding portion 55 towards terminals 61 and 62, respectively, as shown in FIG. 3. Wire portions 51 and 52 extend substantially parallel to the surface where terminals 61 and 62, respectively, of frame 31 are arranged, at the region between bending portion BD and winding portion 55, as shown in FIG. 3. Wire portions 51 and 52 are led out from one end and the other end of one side of the polygon of winding portion 55 in the plan view shown in FIG. 1.

A method of mounting voice coil 50 in a method of manufacturing speaker unit 81 set forth above will be described hereinafter. FIGS. 4-6 are schematic perspective views of the first to third steps, respectively, in the method of mounting a voice coil in the method of manufacturing a speaker unit according to the first embodiment of the present invention. For a better view in FIGS. 4-6, the shape of frame 31 is simplified.

Referring to FIG. 4, frame 31 including terminals 61 and 62 is inserted in a jig (not shown). Then, shaping pins (shaping members) 71 and 72 are inserted from the side corresponding to the jig in a direction indicated by the open arrow in FIG. 4. Accordingly, between terminals 61 and 62 on frame 31, shaping pins 71 and 72 are arranged in the proximity of terminals 61 and 62, respectively, so as to extend parallel to the surface of frame 31.

Referring to FIG. 5, voice coil 50 is inserted into the aforementioned jig. During this insertion, wire portions 51 and 52 are arranged apart from terminals 61 and 62, respectively, and traversing above terminals 61 and 62 in plan view. Shaping pins 71 and 72 are set at a state located between respective wire portions 51,52 and frame 31.

Referring to FIG. 6, wire portions 51 and 52 are pressed against respective terminals 61 and 62 by compression pins 73 and 74, respectively, in a state where shaping pins 71 and 72 are located between respective wire portions 51,52 and frame 31. Accordingly, wire portions 51 and 52 are bent at the region in contact with shaping pins 71 and 72, and connected to terminals 61 and 62, respectively, by compression. In other words, each of wire portions 51 and 52 has a bending portion BD and a compression portion CP formed at the same time. Accordingly, wire portions 51 and 52 are shaped to have a bending portion BD, and extend substantially parallel to the surface where terminals 61 and 62, respectively, of frame 31 are arranged, at the region between bending portion BD and winding portion 55.

Then, any unnecessary portion of wire portions 51 and 52 is removed. Moreover, a protection adhesive is applied to compression portion CP, as necessary. Then, shaping pins 71 and 72 are removed.

Thus, voice coil 50 is mounted as set forth above.

The functional effect of speaker unit 81 of the present embodiment will be described hereinafter, relative to a comparative example.

By including a bending portion BD as shown in FIG. 3 in speaker unit 81 of the present embodiment, the event of wire portions 51 and 52 being disconnected or colliding with another member at the time of operation can be suppressed. This will be described hereinafter relative to a comparative example.

FIG. 7 is a schematic partial sectional view of a configuration of a speaker unit according to a first comparative example. FIG. 8 is a schematic partial sectional view of the voice coil of FIG. 7 in a manner displaced towards the diaphragm. FIG. 9 is a schematic partial sectional view of the voice coil of FIG. 7 displaced in a direction opposite to the diaphragm side.

Referring mainly to FIG. 7, a speaker unit 81S of the first comparative example includes a wire portion 51S extending linearly from winding portion 55 towards terminal 61, absent of a bending portion BD (FIG. 3). Such a shape of wire portion 51S is disadvantageous in that wire portion 51S will be excessively stretched so as to be disconnected when diaphragm 32 is displaced upwards, as shown in FIG. 8 (the direction indicated by the open arrow). Further, when diaphragm 32 is displaced downwards (the direction indicated by the open arrow), as shown in FIG. 9, wire portion 51S will readily collide against a corner CN of yoke 42 attached to frame 31.

In the present embodiment, wire portions 51 and 52 have bending portions BD bent in the vibrating direction DR from winding portion 55 to terminals 61 and 62, respectively, as shown in FIG. 2. Accordingly, the tension of each of wire portions 51 and 52 can be alleviated by the stretching of bending portion BD, as shown in FIG. 15, allowing disconnection of wire portions 51 and 52 (not shown in FIG. 15) to be prevented.

Moreover, wire portions 51 and 52 allow a greater distance from frame 31 to be ensured at the region from winding portion 55 to bending portion BD, as compared to the case where the wire portion extends linearly (FIG. 7). Thus, the wire portion can be prevented from colliding against the frame or another member attached to the frame, as shown in FIG. 16.

According to speaker unit 81 of the present embodiment, winding portion 55 of voice coil 50 takes a polygonal shape in plan view. Therefore, the lateral symmetry of voice coil 50 in plan view can be maintained readily. This will be described hereinafter relative to a comparative example.

FIG. 10 is a schematic plan view of a configuration of a speaker unit in a second comparative example. Referring to FIG. 10, a speaker unit 81R of the second comparative example includes a winding portion 55R of a voice coil 50R. Winding portion 55R takes a circle form in planar shape. Since such a winding portion 55R taking a circular shape allows voice coil 50R to easily rotate relative to diaphragm 32, as shown in FIG. 13, when voice coil 50R is to be fixed to diaphragm 32, the leading end of wire portions 51R and 52R from winding portion 55R cannot be defined. Therefore, the lateral symmetry of the shape of voice coil 50R in plan view cannot be achieved. In this case, not only the symmetry of wire portions 51R and 52R in plan view, but also the horizontal property of wire portions 51R and 52R is disturbed, as shown in FIG. 14. As a result, the acoustic property of speaker unit 81R may be adversely affected.

In the present first embodiment, winding portion 55 (FIG. 1) is wound to take a polygonal shape in plan view. By immobilizing the corner of winding portion 55, deviation in position caused by rotation of winding portion 55 can be prevented.

According to the method of manufacturing speaker unit 81 of the present embodiment, the steps are simplified by forming bending portion BD and compression portion CP at the same time, as shown in FIG. 6. Further, since bending portion BD is bent in the vibrating direction DR, the symmetry of voice coil 50 can be easily maintained. This will be described hereinafter relative to a comparative example.

FIGS. 11 and 12 are schematic perspective views of the first and second steps, respectively, of a method of mounting a voice coil in the method of manufacturing a speaker unit according to a second comparative example.

Referring to FIG. 11, shaping pins 71N and 72N are arranged in proximity to terminals 61 and 62, respectively, so as to extend perpendicular to the surface of frame 31. Then, voice coil 50R is disposed.

As indicated by the open arrow in FIG. 11, wire portions 51R and 52R are wound to run along a portion of the outer circumference of shaping pins 71N and 72N, respectively. Accordingly, a bending portion BN is formed at each of wire portions 51R and 52R.

Referring to FIG. 12, compression portion CP is formed by pressing wire portions 51R and 52R against terminals 61 and 62 by compression pins 73 and 74, respectively.

In the present comparative example, the process is cumbersome since the step of forming bending portion BN (FIG. 11) and the step of forming compression portion CP (FIG. 12) are carried separately.

Moreover, since bending portion BN of voice coil 50R (FIG. 10) is bent in a direction perpendicular to the vibrating direction of diaphragm 32 (in-plane direction in FIG. 10), the spring force of bending portion BN may act (spring back) in a direction perpendicular to the vibrating direction (in-plane direction in FIG. 10). This action may induce deviation in position (FIG. 13) caused by rotation, or disturb the symmetry of voice coil 50R in plan view.

In the present embodiment, a bending portion BD can be formed at each of wire portions 51 and 52, by wire portions 51 and 52 being bent at the region in contact with shaping pins 71 and 72, respectively. Moreover, the formation of this bending portion BD may be carried out simultaneous to the connection of wire portions 51 and 52 to terminals 61 and 62, respectively, by compression portion CP. Therefore, the process can be simplified as compared to the case where bending portion BN and compression portion CP are formed in different steps, as shown in FIGS. 11 and 12.

Since bending portion BD is bent in the vibrating direction DR (FIG. 2), the spring force of bending portion BD will not act in the direction perpendicular to the vibrating direction DR (FIG. 2) of bending portion BD (in-plane direction in FIG. 10), differing from bending portion BN bent perpendicular to the vibrating direction (FIG. 10). Thus, the event of the symmetry of voice coil 50 in plan view being disturbed by the action of the spring force can be avoided.

Although the present embodiment has been described based on a diaphragm 32 (FIG. 1) having an elliptical shape in plan view, the present invention is not limited thereto. For example, a configuration in which a diaphragm 32a having a track type shape is mounted to frame 31a, as shown in FIG. 17, or a configuration in which a diaphragm 32b having a circular shape is mounted to frame 31b, as shown in FIG. 18, may be employed.

Although a winding portion 55 (FIG. 1) having a regular polygonal shape (FIG. 1) in plan view has been described in the present embodiment, the present invention is not limited thereto. For example, a winding portion 55W having a hexagonal shape lengthened in one direction (horizontal direction in the drawing), as shown in FIG. 19, may be employed.

### Second Embodiment

FIG. 20 is a schematic plan view of a configuration of a speaker unit according to a second embodiment of the present invention. FIG. 21 is a schematic partial side view of a configuration of a voice coil at a point in view in the direction of the open arrow in FIG. 20.

Referring to FIGS. 20 and 21, a speaker unit 81v of the present embodiment includes a voice coil 50v, instead of a voice coil 50 of the first embodiment. Voice coil 50v includes wire portions 51v and 52v. Each of wire portions 51v and 52v is led out from one vertex of the polygon of winding portion 55. The lead out of wire portions 51v and 52v from winding portion 55 is effected in the forward direction with respect to the winding direction such that the line between each of wire portions 51v and 52v and winding portion 55 is not bent acutely.

A method of mounting voice coil 50v in the method of manufacturing speaker unit 81v will be described hereinafter. FIG. 22 is a schematic perspective view of a step in a method of mounting a voice coil in the method of manufacturing a speaker unit in the second embodiment of the present invention. For a better view, the shape of frame 31 is simplified in FIG. 22.

Referring to FIG. 22, a frame 31 including terminals 61 and 62 is inserted into a jig (not shown). Then, a shaping pin (shaping member) 70 is inserted from the side corresponding to this jig. Accordingly, shaping pin 70 is arranged in the proximity of terminals 61 and 62 so as to extend parallel to the surface of frame 31, passing through one side of the pair of terminals 61 and 62 on frame 31 (right side in the drawing).

Then, voice coil 50v is inserted into the jig set forth above. Winding portion 55 is arranged such that shaping pin 70 is located between the pair of terminals 61 and 62 and winding portion 55 in plan view. Wire portions 51v and 52v are arranged apart from traverse terminals 61 and 62 and so as to traverse terminals 61 and 62, respectively, in plan view. Accordingly, shaping pin 70 attains a state located between each of wire portions 51v and 52v and frame 31.

Wire portions 51v and 52v are pressed against terminals 61 and 62 by compression pins 73 and 74, respectively, under the state where shaping pin 70 is located between each of wire portions 51v and 52v and frame 31, as described above. Accordingly, wire portions 51v and 52v are bent at the region in contact with shaping pin 70, and connected to terminals 61 and 62, respectively, by compression. In other words, a bending portion BD and compression portion CP are formed at the same time at each of wire portions 51v and 52v.

Then, any unnecessary portion of wire portions 51v and 52v is removed. Furthermore, a protective adhesive is applied to compression portion CP, as necessary. Then, shaping pin 70 is removed.

Thus, voice coil 50v is mounted as set forth above.

The remaining configuration is substantially similar to that of the first embodiment set forth above. The same or corresponding elements have the same reference characters allotted, and description thereof will not be repeated.

According to the present embodiment, an advantage similar to that of the first embodiment is achieved. Furthermore, a bending portion BD can be formed at both wire portions 51v and 52v by one shaping pin 70.

### Third Embodiment

FIG. 23 is a schematic partial perspective view of a configuration of a portable information terminal from the operation panel side according to a third embodiment of the present invention. FIG. 24 is a schematic partial perspective view of a configuration of the portable information terminal of FIG. 23 from the backside.

Referring to FIGS. 23 and 24, a portable information terminal of the present embodiment is a mobile phone, including an upper case 101, a display 102, a sound emission hole 103, a hinge 104, a lower case 105, an operation button 106, a numeric button 107, a display 111, a sound emission hole 112, and a plurality of speaker units 81 (not shown in FIGS. 23 and 24).

In the proximity of sound emission hole 103, one speaker unit 81 is incorporated as a receiver emitting the receiving sound or the like. In the proximity of sound emission hole 112, another speaker unit 81 is incorporated as a speaker emitting a ring tone or the like.

The remaining configuration is substantially identical to that of the first embodiment set forth above. The same or corresponding elements have the same reference characters allotted, and description thereof will not be repeated.

The portable information terminal of the present embodiment including speaker unit 81 allows the mounting space for speaker unit 81 to be reduced while preventing disconnection and/or collision of wire portions 51 and 52, as described in the first embodiment. Therefore, the portable information terminal can be further reduced in size, thickness, and weight.

It should be understood that the embodiments disclosed herein are illustrative and non-restrictive in every respect. The scope of the present invention is defined by the terms of the claims, rather than the description of the embodiments set forth above, and is intended to include any modifications within the scope and meaning equivalent to the terms of the claims.

### INDUSTRIAL FIELD

The present invention is advantageously applied to a speaker unit including a voice coil, a manufacturing method thereof, and a portable information terminal.

### BRIEF DESCRIPTION OF THE DRAWINGS

FIG. 1 is a schematic plan view of a configuration of a speaker unit according to a first embodiment of the present invention.

FIG. 2 is a schematic sectional view taken along line II-II in FIG. 1.

FIG. 3 is a schematic enlarged view in the vicinity of arrow III in FIG. 2.

FIG. 4 is a schematic perspective view of a first step in a method of mounting a voice coil in the method of manufacturing a speaker unit according to the first embodiment of the present invention.

FIG. 5 is a schematic perspective view of a second step in a method of mounting a voice coil in the method of manufacturing a speaker unit according to the first embodiment of the present invention.

FIG. 6 is a schematic perspective view of a third step in a method of mounting a voice coil in the method of manufacturing a speaker unit according to the first embodiment of the present invention.

FIG. 7 is a schematic partial sectional view of a configuration of a speaker unit of a first comparative example.

FIG. 8 is a schematic partial sectional view of the voice coil of FIG. 7 in a manner displaced towards the diaphragm.

FIG. 9 is a schematic partial sectional view of the voice coil of FIG. 7 displaced in a direction opposite to the diaphragm side.

FIG. 10 is a schematic plan view of a configuration of a speaker unit according to a second comparative example.

FIG. 11 is a schematic perspective view of a first step in a method of mounting a voice coil in a method of manufacturing a speaker unit of the second comparative example.

FIG. 12 is a schematic perspective view of a second step in a method of mounting a voice coil in a method of manufacturing a speaker unit of the second comparative example.

FIG. 13 is a schematic plan view of the winding portion of the voice coil of FIG. 10 in a state where deviation in position is caused by rotation of the winding portion.

FIG. 14 is a schematic sectional view of FIG. 13.

FIG. 15 is a schematic partial sectional view of the voice coil of FIG. 3 displaced towards the diaphragm side.

FIG. 16 is a schematic partial sectional view of the voice coil of FIG. 3 displaced in a direction opposite to the diaphragm side.

FIG. 17 is a schematic plan view of a configuration of a speaker unit according to a first modification in the first embodiment of the present invention.

FIG. 18 is a schematic plan view of a configuration of a speaker unit according to a second modification in the first embodiment of the present invention.

FIG. 19 is a schematic plan view of a configuration of a speaker unit according to a third modification in the first embodiment of the present invention.

FIG. 20 is a schematic plan view of a configuration of a speaker unit according to a second embodiment of the present invention.

FIG. 21 is a schematic partial side view of a configuration of a voice coil at a point in view in the direction of the open arrow in FIG. 20.

FIG. 22 is a schematic perspective view of a step in a method of mounting a voice coil in the method of manufacturing a speaker unit in the second embodiment of the present invention.

FIG. 23 is a schematic partial perspective view of a configuration of a portable information terminal from the operation panel side according to a third embodiment of the present invention.

FIG. 24 is a schematic partial perspective view of a configuration of the portable information terminal of FIG. 23 from the backside.

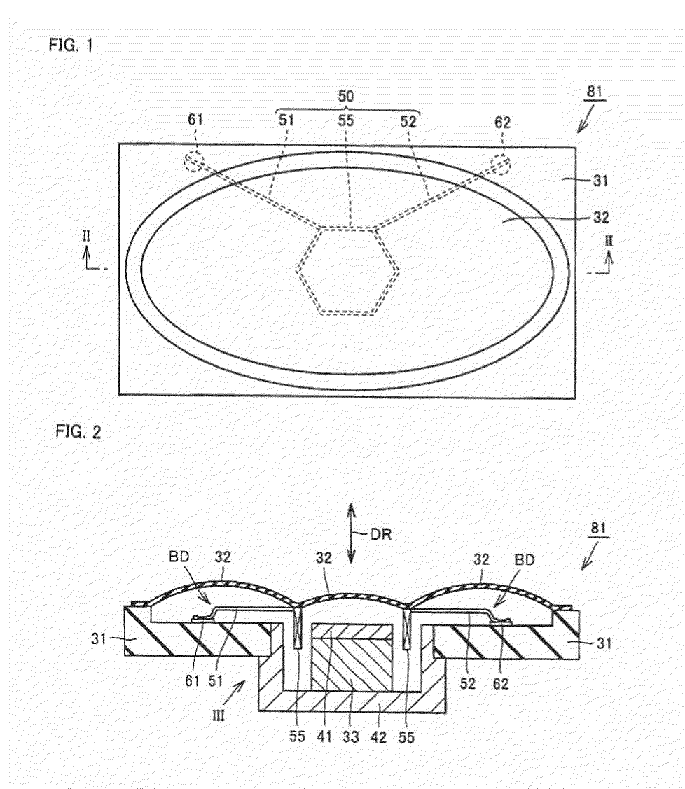

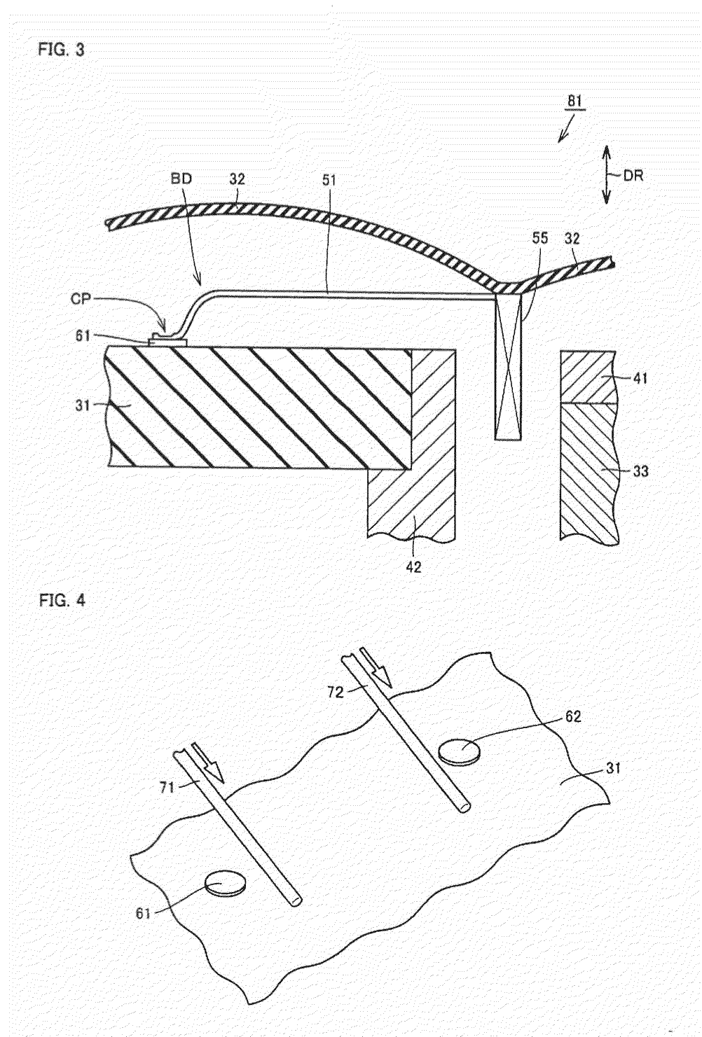

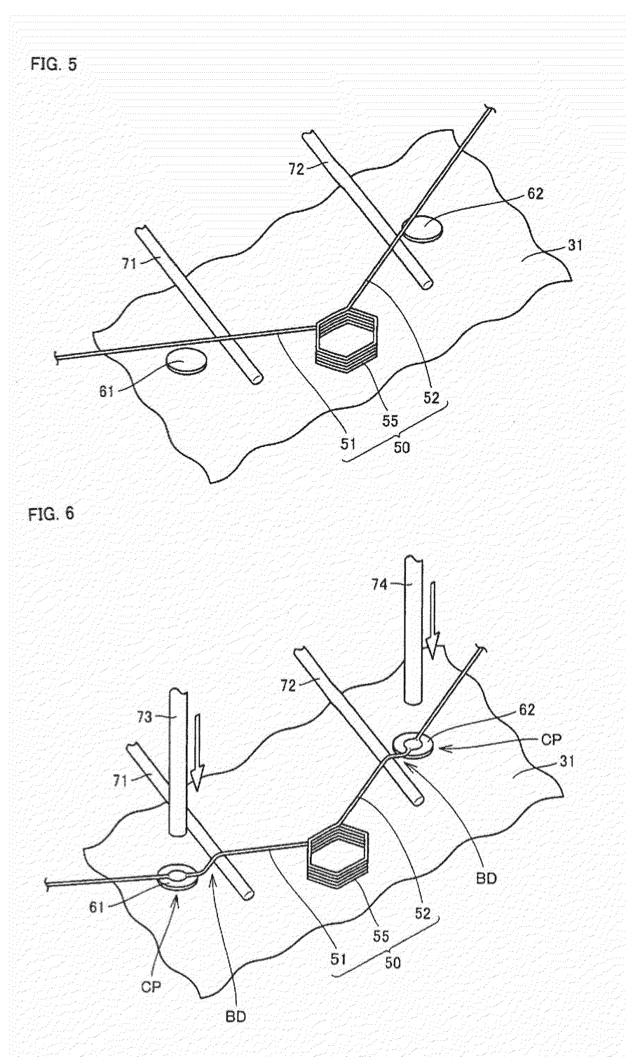

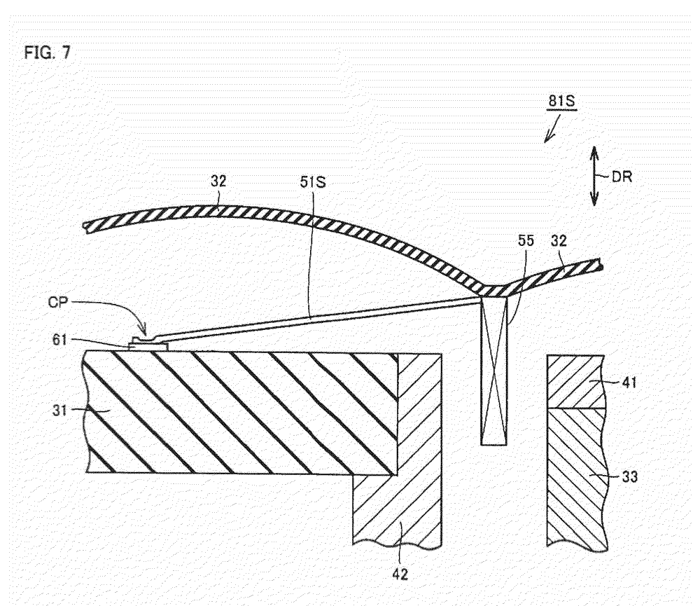

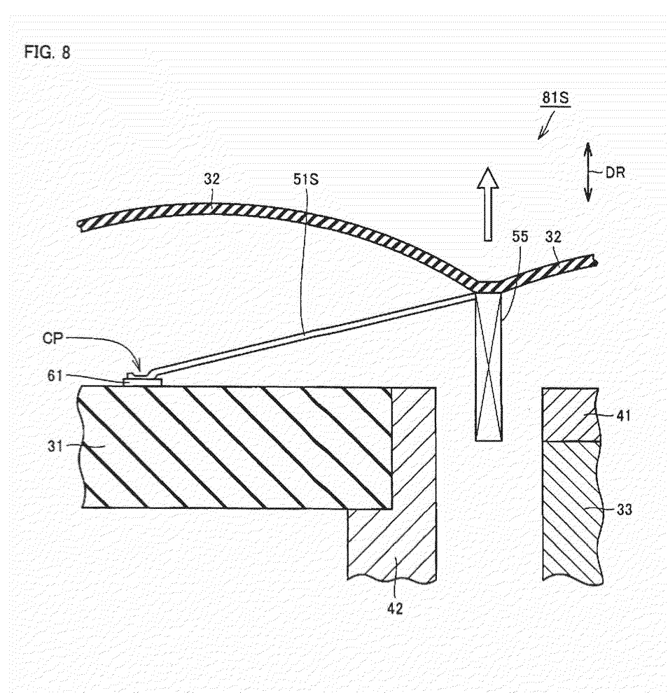

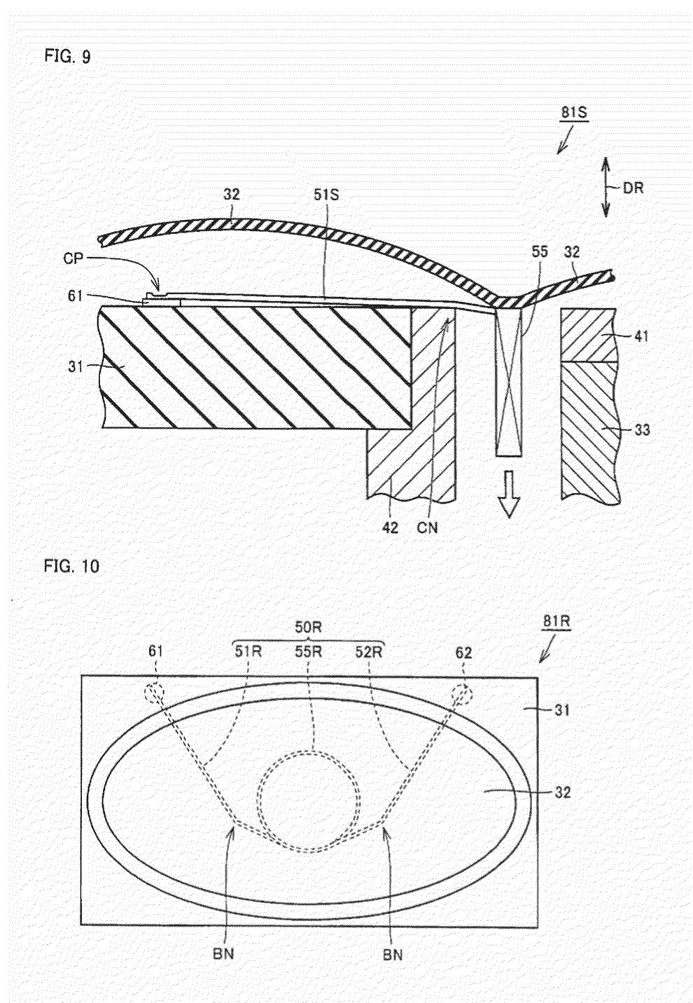

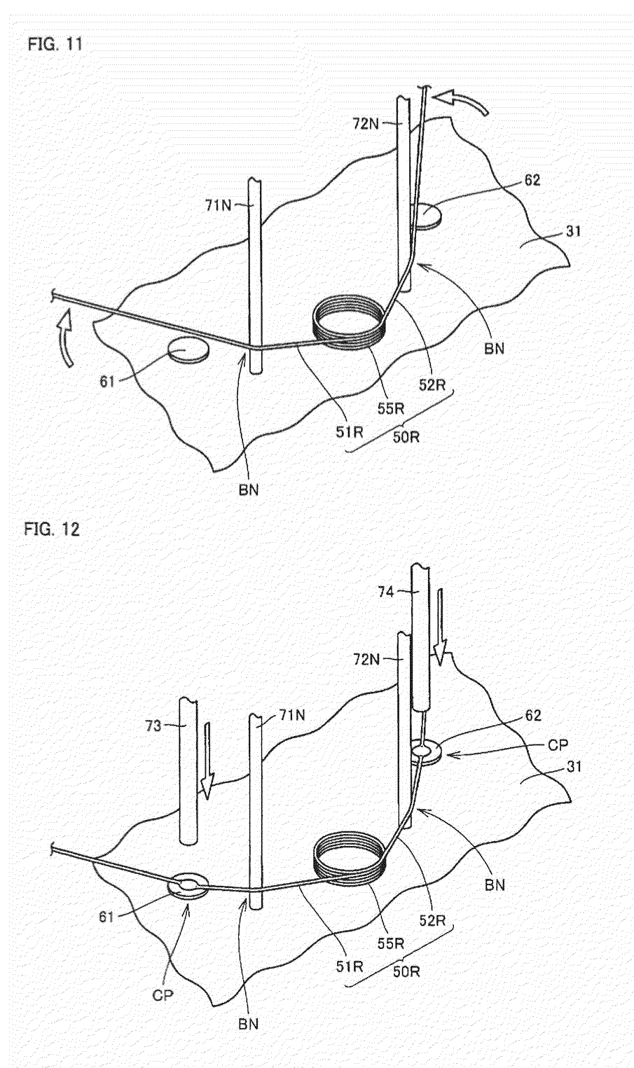

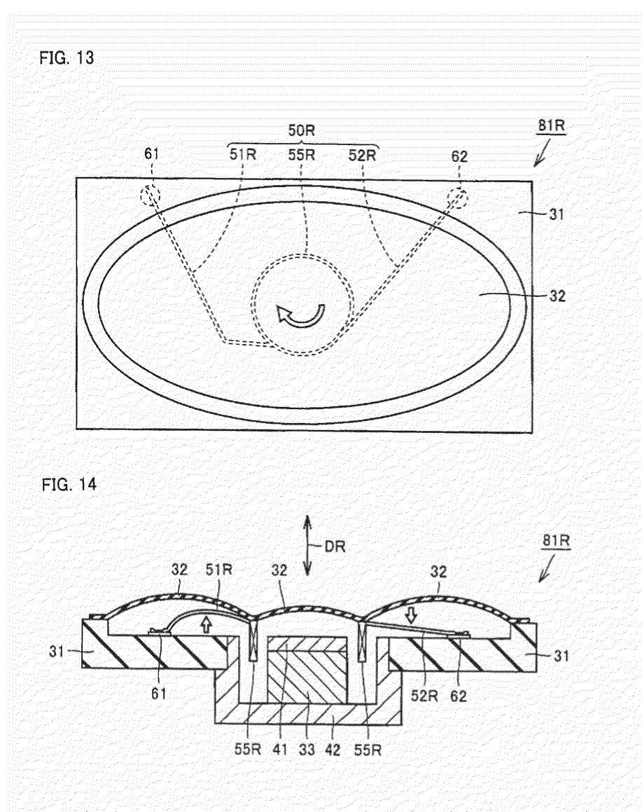

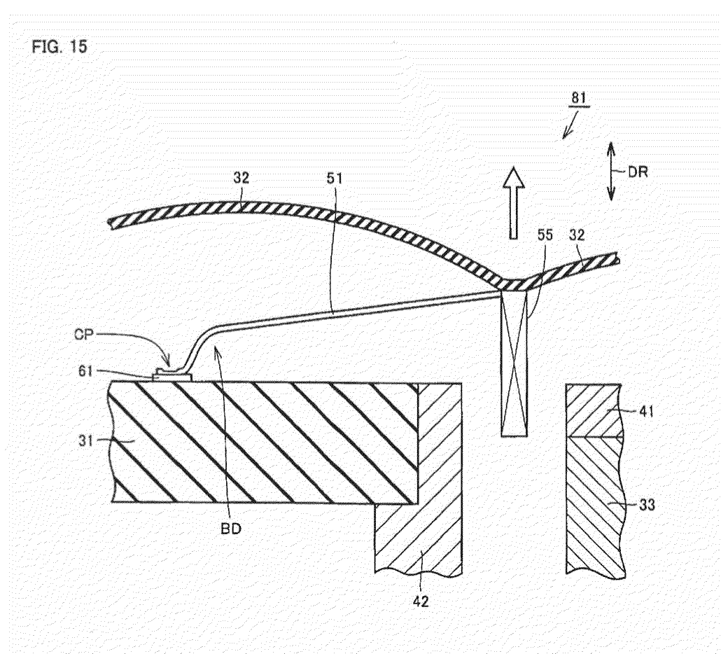

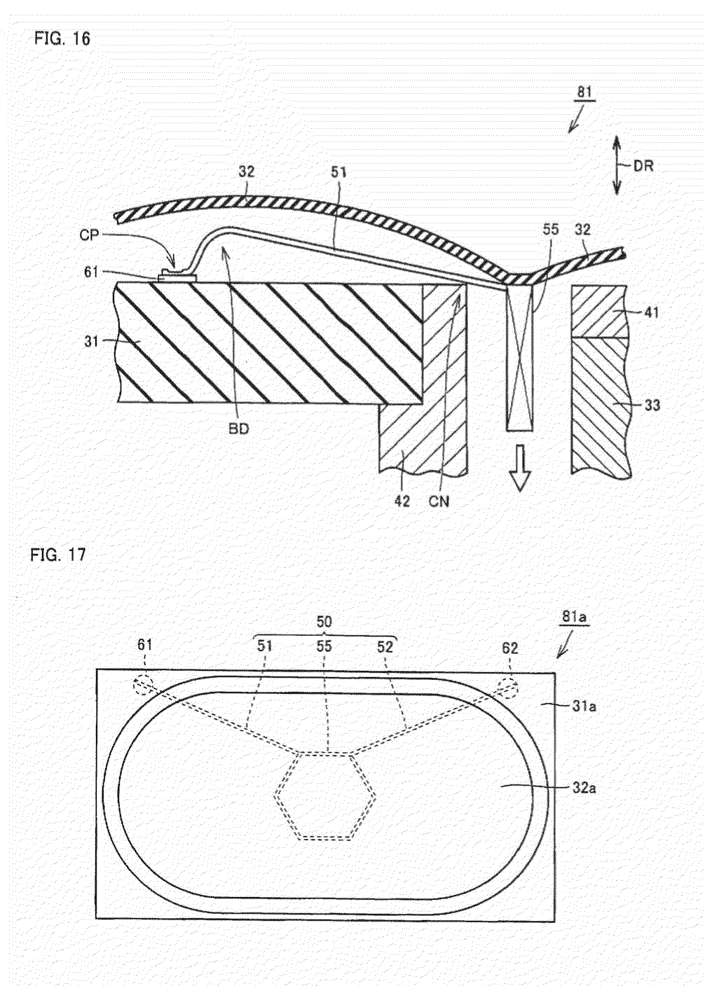

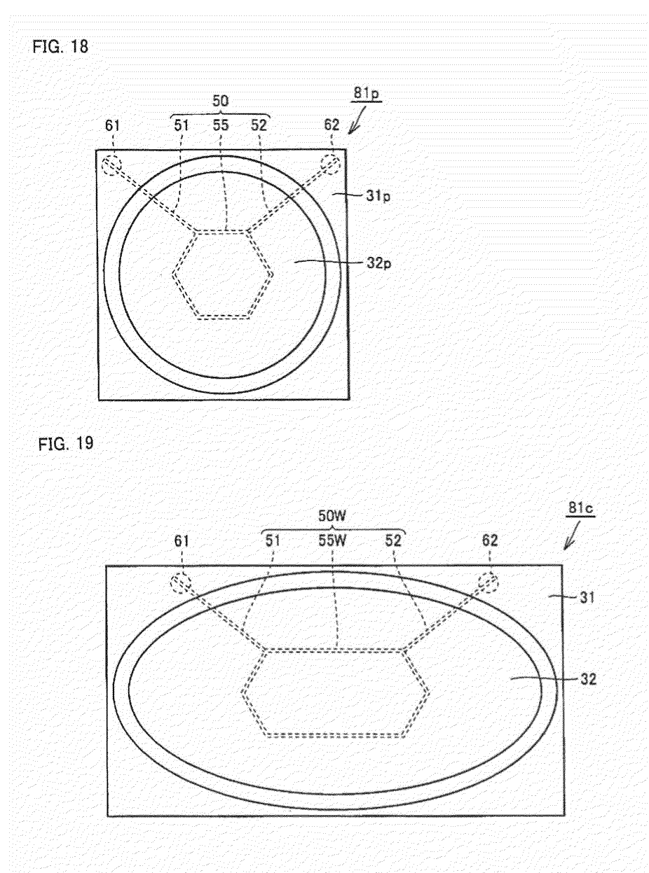

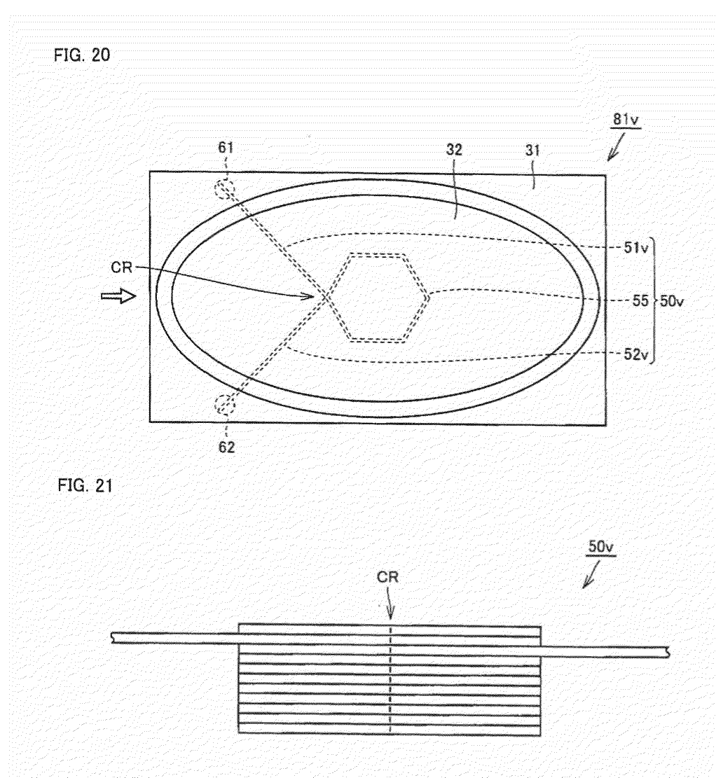

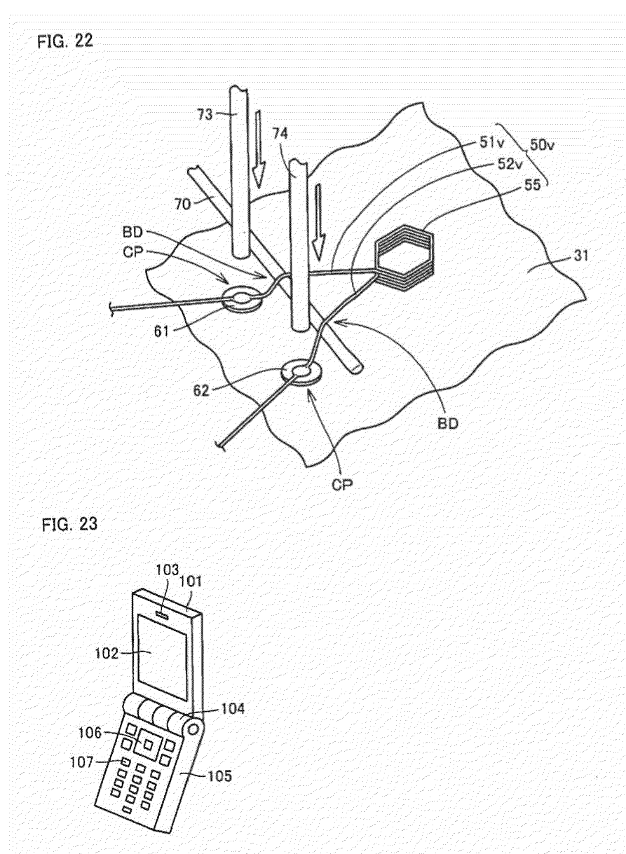

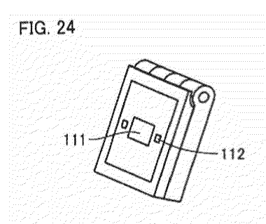

### DESCRIPTION OF THE REFERENCE CHARACTERS

31, 31a, 31b frame; 32, 32a, 32b diaphragm; 33 magnet; 41 pole piece; 42 yoke; 50, 50v voice coil; 51, 51v, 52, 52v wire portion; 55 winding portion 55W winding portion; 61, 62 terminal; 70, 71, 72 shaping pin; 73, 74 compression pin; 81, 81v speaker unit; BN bending portion; CP compression portion; DR vibrating direction.

1. A speaker unit comprising:
a frame including a terminal,
a diaphragm supported by said frame so as to vibrate in one direction,
a magnet fixed to said frame, and
a voice coil including a winding portion fixed to said diaphragm to receive a magnetic field from said magnet, and a wire portion which electrically connects said winding portion and said terminal,
said wire portion having a bending portion bent in said one direction from said winding portion towards said terminal.

2. The speaker unit according to claim 1, wherein said winding portion is wound to take a polygonal shape in plan view.

3. A portable information terminal comprising the speaker unit defined in claim 1.

4. A method of manufacturing a speaker unit which includes
a frame including a terminal,
a diaphragm supported by said frame so as to vibrate in one direction,
a magnet fixed to said frame, and
a voice coil including a winding portion fixed to said diaphragm to receive a magnetic field from said magnet, and a wire portion which electrically connects said winding portion and said terminal, said method comprising the steps of:
arranging said wire portion spaced apart from said terminal, and traversing over said terminal in plan view, and
bending said wire portion at a region in contact with a shaping member and connecting said wire portion to said terminal by pressing said wire portion against said terminal in a state where said shaping member is located between said frame and said wire portion.

5. The method of manufacturing a speaker unit according to claim 4, wherein said winding portion is wound to take a polygonal shape in plan view.
